(19) United States
(12) Patent Application Publication
(10) Pub. No.: US 2022/0377095 A1
(43) Pub. Date: Nov. 24, 2022

(54) APPARATUS AND METHOD FOR DETECTING WEB SCANNING ATTACK

(71) Applicant: SAMSUNG SDS CO., LTD., Seoul (KR)

(72) Inventors: Jung-Eun LEE, Seoul (KR); Jang-Ho KIM, Seoul (KR); Jung-Bae JUN, Seoul (KR); Dae-Yong KIM, Seoul (KR)

(21) Appl. No.: 17/749,477

(22) Filed: May 20, 2022

(30) Foreign Application Priority Data
May 21, 2021 (KR) 10-2021-0065237

(51) Int. Cl. H04L 9/40; G06K 9/62

(52) U.S. Cl. CPC H04L 63/1425; H04L 63/1416; G06K 9/6215; G06K 9/6267

(57) ABSTRACT

A web scanning attack detection device includes a web log collector collecting web logs generated for a preset time with respect to each of at least one client connected to a web site, a field value extractor extracting field values for a target field from the web logs, a classifier calculating an appearance frequency of each of the field values in the web logs and classify each of the field values as one of a normal group and a candidate group based on the appearance frequency, and a detector calculating a similarity between each field value classified as the normal group and each field value classified as the candidate group, detects an anomaly field value among each field value classified as the candidate group based on the similarity, and detecting an anomaly web log including the anomaly field value among the web logs.

### CROSS-REFERENCE TO RELATED APPLICATION(S)

This application claims the benefit under 35 USC § 119 of Korean Patent Application No. 10-2021-0065237, filed on May 21, 2021, in the Korean Intellectual Property Office, the entire disclosure of which is incorporated herein by reference for all purposes.

### BACKGROUND

### 1. Field

Embodiments disclosed herein relate to a technology for detecting a web scanning attack.

### 2. Description of Related Art

A web scanning attack is an attack for identifying the presence/absence of a web page and the type, version, directory information, vulnerable points, and the like of a web server by receiving a response code for a request from the web server after sending the request to the web server.

In general, a rule-based detection system is mainly used to defend against a web scanning attack, but is limited in detection of attacks on vulnerable points that are not known. Moreover, this system frequently depends on experience of an operator since a false positive rate may vary according to how a detection rule is established and applied.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a device and method for detecting a web scanning attack.

In one general aspect, there is provided a web scanning attack detection device including a web log collector that collects a plurality of web logs generated for a preset time with respect to each of at least one client connected to a web site; a field value extractor that extracts a plurality of field values for a target field from the plurality of web logs; a classifier that calculates an appearance frequency of each of the plurality of field values in the plurality of web logs and classify each of the plurality of field values as one of a normal group and a candidate group based on the appearance frequency; and a detector that calculates a similarity between each field value classified as the normal group and each field value classified as the candidate group, detects an anomaly field value among each field value classified as the candidate group based on the similarity, and detects an anomaly web log including the anomaly field value among the plurality of web logs.

The classifier may classify, as the candidate group, a field value having the appearance frequency that is less than a preset first threshold value among the plurality of field values.

The detector may generate a token set for each of the plurality of field values by tokenizing each of the plurality of field values, and calculate the similarity using the token set for each field value classified as the normal group and the token set for each field value classified as the candidate group.

The similarity may be a Jaccard similarity.

The detector may calculate a score for each field value classified as the candidate group based on the similarity, and detect the anomaly field value among each field value classified as the candidate group based on the score.

The detector may calculate the score for each field value classified as the candidate group by adding up the similarity between each field value classified as the candidate group and each field value classified as the normal group.

The detector may detect, as the anomaly field value, a field value having the score that is less than a preset second threshold value among each field value classified as the candidate group.

In another general aspect, there is provided a web scanning attack detection method including: collecting a plurality of web logs generated for a preset time with respect to each of at least one client connected to a web site; extracting a plurality of field values for a target field from the plurality of web logs; calculating an appearance frequency of each of the plurality of field values in the plurality of web logs; classifying each of the plurality of field values as one of a normal group and a candidate group based on the appearance frequency; calculating a similarity between each field value classified as the normal group and each field value classified as the candidate group; detecting an anomaly field value among each field value classified as the candidate group based on the similarity; and detecting an anomaly web log including the anomaly field value among the plurality of web logs.

In the classifying, a field value having the appearance frequency that is less than a preset first threshold value among the plurality of field values may be classified as the candidate group.

The calculating of the similarity may include: generating a token set for each of the plurality of field values by tokenizing each of the plurality of field values; and calculating the similarity using the token set for each field value classified as the normal group and the token set for each field value classified as the candidate group.

The similarity may be a Jaccard similarity.

The detecting of the anomaly field value may include: calculating a score for each field value classified as the candidate group based on the similarity; and detecting the anomaly field value among each field value classified as the candidate group based on the score.

In the calculating of the score, the score for each field value classified as the candidate group may be calculated by adding up the similarity between each field value classified as the candidate group and each field value classified as the normal group.

In the detecting of the anomaly field value, a field value having the score that is less than a preset second threshold value among each field value classified as the candidate group may be detected as the anomaly field value.

### BRIEF DESCRIPTION OF THE DRAWINGS

FIG. 1 is a configuration diagram illustrating a web scanning attack detection device according to an embodiment.

FIG. 2 is a diagram for describing an example of extraction of a field value for a target field according to an embodiment.

FIGS. 3 and 4 are diagrams for exemplarily describing calculation of an appearance frequency of a field value a according to an embodiment.

FIG. 5 is a flowchart illustrating a web scanning attack detection method according to an embodiment.

FIG. 6 is a block diagram exemplarily illustrating a computing environment that includes a computing device according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only illustrative, and the present disclosure is not limited thereto.

In describing embodiments of the present disclosure, when a specific description of known technology related to the present disclosure is deemed to make the gist of the present disclosure unnecessarily vague, the detailed description thereof will be omitted. The terms used below are defined in consideration of functions in the present disclosure, but may vary in accordance with the customary practice or the intention of a user or an operator. Therefore, the terms should be defined based on whole content throughout the present specification. The terms used herein are only for describing the embodiments of the present disclosure, and should not be construed as limitative. A singular expression includes a plural meaning unless clearly used otherwise. In the present description, expressions such as “include” or “have” are for referring to certain characteristics, numbers, steps, operations, components, some or combinations thereof, and should not be construed as excluding the presence or possibility of one or more other characteristics, numbers, steps, operations, components, some or combinations thereof besides those described.

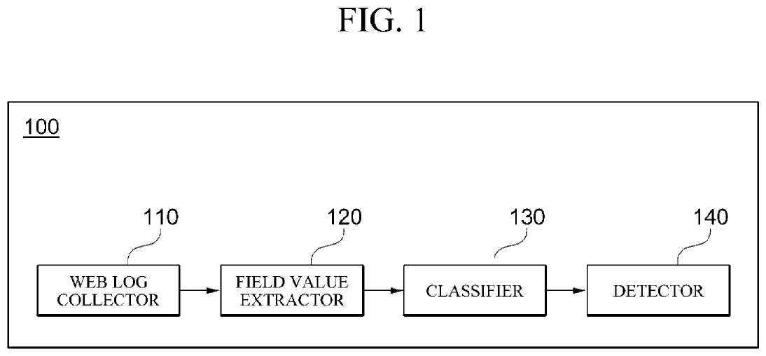

FIG. 1 is a configuration diagram illustrating a web scanning attack detection device according to an embodiment.

Referring to FIG. 1, a web scanning attack detection device 100 according to an embodiment is intended to detect a web scanning attack on a web site based on a web log, and includes a web log collector 110, a field value extractor 120, a classifier 130, and a detector 140.

According to an embodiment, the web log collector 110, the field value extractor 120, the classifier 130, and the detector 140 each may be implemented using one or more physically separated devices or may be implemented using at least one hardware processor or a combination of at least one hardware processor and software, and may not be clearly differentiated from each other in terms of specific operation unlike the illustrated example.

The web log collector 110 collects a plurality of web logs generated for a preset time with respect to each of at least one client connected to a web site.

Hereinafter, the term “web log” represents log data in which a variety of information related to a client connected to a web site is recorded by a web server (not shown) that provides the web site. In detail, the web log may include a plurality of fields in which data related to a client connected to a web site is recorded. For example, the web log may include an IP address field in which an Internet protocol (IP) address of a client connected to a web site is recorded, a date field in which a connection date of a client is recorded, a time filed in which a connection time point of a client is recorded, a uniform resource identifier (URI) field in which a URI requested by a client is recorded, a field (e.g., referrer field) in which a web site incoming path of a client is recorded, a field (e.g., user agent field) in which information (e.g., the name, version, and the like of each of a web browser and an operating system) related to a web browser and an operating system used by a client when connecting to a web site is recorded, etc. However, the types and number of fields included in the web log may be variously changed according to a format and application environment of the web log.

The web log collector 110 may collect, from the web server, the web log generated by the web server for a preset time (e.g., 10 minutes), or, according to an embodiment, may collect the web log generated by the web server for a preset time from a separate database, which stores the web log generated by the web server. Here, the preset time may be variously changed according to an embodiment.

The field value extractor 120 extracts a plurality of field values for a target field from a plurality of web logs collected by the web log collector 110.

According to an embodiment, the target field may represent a field preset as an anomaly field value detection target among a plurality of fields included in each of collected web logs. In detail, the target field may be preset by a user who desires to detect a web scanning attack on a web site using the web scanning attack detection device 100 (hereinafter simply referred to as a user), and may be differently set according to an embodiment. Furthermore, according to an embodiment, the number of target fields may be at least one.

According to an embodiment, the field value extractor 120 may obtain a plurality of field values for a target field by extracting field values from a target field included in each of a plurality of web logs.

Here, according to an embodiment, the field value extractor 120 may extract, as a field value, a value itself recorded in the target field included in each of a plurality of web logs. However, according to an embodiment, the field value extractor 120 may extract, as a field value, a preprocessed value by performing preset preprocessing on a value recorded in a target field, or may extract a portion of values recorded in a target field as a field value. Here, the preprocessing may include, for example, null value removal, preset stopword removal, and the like, and other various types of preprocessing may be performed according to an embodiment.

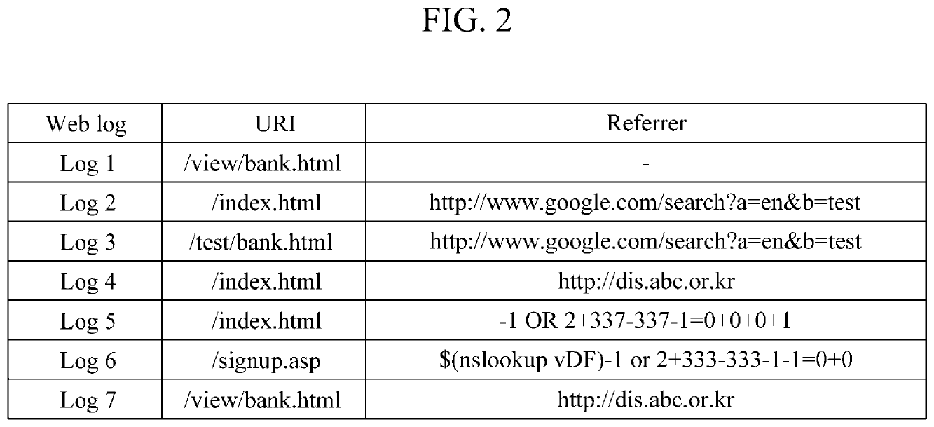

FIG. 2 is a diagram for describing an example of extraction of a field value for a target field according to an embodiment.

In detail, the example of FIG. 2 illustrates values extracted from a referrer field and a URI field included in each of seven web logs (i.e., Log 1, Log 2, Log 3, Log 4, Log 5, Log 6, Log 7) collected by the web log collector 110.

In the example of FIG. 2, when the URI field is assumed to be a target field, the field value extractor 120 may extract, as field values for the target field, “/view/bank.html” recorded in the URI fields of Log 1 and Log 7, “/index.html” recorded in the URI fields of Log 2, Log 4, and Log 5, “/test/bank.html” recorded in the URI field of Log 3, and “/signup.asp” recorded in the URI field of Log 6.

For another example, when the referrer field is assumed to be a target field, the field value extractor 120 may extract, as field values for the target field, “http://www.google.com/search?a=en&b=test” recorded in the referrer fields of Log 2 and Log 3, “http://dis.abc.or.kr” recorded in the referrer fields of Log 4 and Log 7, “−1 OR 2+337−337−1=0+0+0+1” recorded in the referrer field of Log 5, and “$(nslookup vDF)−1 or 2+333−333−1−1=0+0” recorded in the referrer field of Log 6 except for a null value included in Log 1.

For another example, when it is assumed that the referrer field is a target field and “http://” is preset as a stopword, the field value extractor 120 may extract, as field values for the target field, “www.google.com/search?a=en&b=test”, “dis.abc.or.kr”, “−1 OR 2+337−337−1=0+0+0+1”, and “$(nslookup vDF)−1 or 2+333−333−1−1=0+0” unlike the above example.

Referring back to FIG. 1, the classifier 130 calculates an appearance frequency of each of a plurality of field values for a target field in a plurality of web logs collected by the web log collector 110. Furthermore, the classifier 130 classifies each of the plurality of field values as one of a normal group and a candidate group based on the calculated appearance frequency.

Here, the appearance frequency of each field value may be calculated as the number of web logs including each field value among the plurality of web logs.

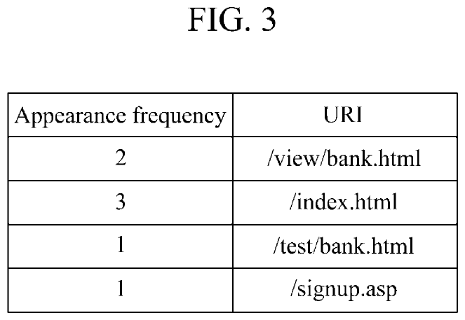

For example, in the example of FIG. 2, when it is assumed that “/view/bank.html”, “/index.html”, “/test/bank.html”, and “/signup.asp” are extracted as field values for a target field, the appearance frequency of each field value may be calculated as illustrated in FIG. 3.

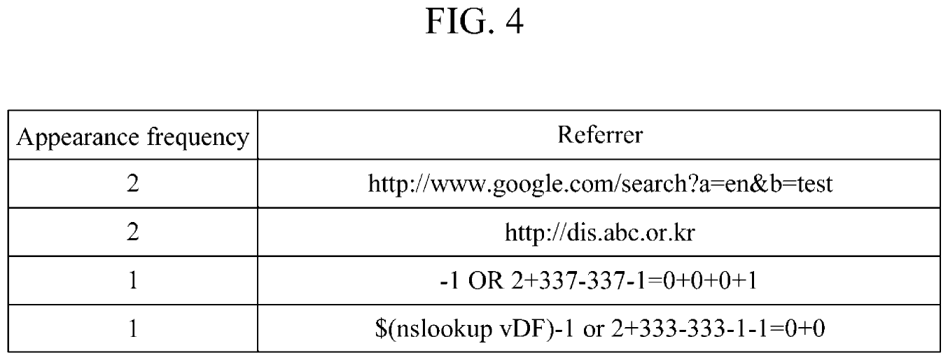

For example, in the example of FIG. 2, when it is assumed that “http://www.google.com/search?a=en&b=test”, “http://dis.abc.or.kr”, “−1 OR 2+337−337−1=0+0+0+1”, and “$(nslookup vDF)−1 or 2+333−333−1−1=0+0” are extracted as field values for a target field, the appearance frequency of each field value may be calculated as illustrated in FIG. 4.

According to an embodiment, the classifier 130 may classify, as a candidate group, field values having appearance frequencies that are less than a first threshold value among field values extracted by the field value extractor 120, and may classify, as a normal group, field values having appearance frequencies that are at least the first threshold value. Here, the first threshold value may be preset by a user, and may be changed according to an embodiment.

For example, when it is assumed that the first threshold value is 2 and extracted field values and the appearance frequency of each field value are the same as illustrated in FIG. 3, the classifier 130 may classify, as a candidate group, “/test/bank.html” and “/signup.asp” of which the appearance frequencies are 1 among the extracted field values, and may classify, as a normal group, “/view/bank.html” and “/index.html” of which the appearance frequencies are at least 2.

The detector 140 calculates a similarity between each field value classified by the classifier 130 as the normal group and each field value classified as the candidate group, and detects an anomaly field value among each field value classified as the candidate group based on the calculated similarity.

According to an embodiment, the detector 140 may generate a token set for each of a plurality of field values by tokenizing each of the plurality of field values including each field value classified as the normal group and each field value classified as the candidate group. Furthermore, the detector 140 may calculate the similarity between each field value classified as the normal group and each field value classified as the candidate group using the token set for each field value classified as the normal group and the token set for each field value classified as the candidate group.

Here, according to an embodiment, the detector 140 may tokenize each of the plurality of field values according to a preset criterion.

For example, when the target field is the URI field, and extracted field values are the same as illustrated in FIG. 3, the detector 140 may extract, as a token, each character string divided by a special character (i.e., ‘/’ and ‘.’) from each field value, and may generate a token set including each extracted token. In detail, the token set for the field value “view/bank.html” may be a set including “view”, “bank”, and “html” as tokens, and the token set for the field value “/test/bank.html” may be a set including “test”, “bank”, and “html” as tokens.

The preset criterion for tokenization is not limited to the above-mentioned examples, and may be variously set in consideration of a format of a field value extracted from a target field.

According to an embodiment, the detector 140 may calculate a Jaccard similarity between the token set for each field value classified as the normal group and the token set for each field value classified as the candidate group as the similarity between each field value classified as the normal group and each field value classified as the candidate group.

According to another embodiment, the detector 140 may generate vectors respectively corresponding to the token set for each field value classified as the normal group and the token set for each field value classified as the candidate group using a vectorization technique such as term frequency-inverse document frequency (TF-IDF), one-hot encoding, word embedding, and the like. Furthermore, the detector 140 may calculate the similarity between each field value classified as the normal group and each field value classified as the candidate group using the generated vectors. In this case, the similarity may be, for example, a cosine similarity or Euclidean distance.

According to an embodiment, the detector 140 may calculate a score for each field value classified as the candidate group based on the similarity between each field value classified as the normal group and each field value classified as the candidate group, and may detect an anomaly field value among each field value classified as the candidate group based on the calculated score.

In detail, the detector 140 may calculate the score for each field value classified as the candidate group by adding up the similarity between each field value classified as the candidate group and each field value classified as the normal group. For example, when it is assumed that the similarity between a field value ‘a’ classified as the candidate group and a field value ‘b’ classified as the normal group is 0.2, and the similarity between the field value ‘a’ and a field value ‘c’ classified as the normal group is 0.5, the score for the field value ‘a’ may be calculated as 0.7 (i.e., 0.2+0.5).

According to an embodiment, when the score for each field value classified as the candidate group is calculated, the detector 140 may detect, as an anomaly field value, a field value having a calculated score that is less than a preset second threshold value among each field value classified as the candidate group. Here, the second threshold value may be preset by a user, and may be changed according to an embodiment.

When an anomaly field value is detected, the detector 140 detects an anomaly web log including the detected anomaly field value among a plurality of web logs collected by the web log collector 110.

In detail, in the examples of FIGS. 2 and 4, when it is assumed that “−1 OR 2+337−337−1=0+0+0+1” and “$(nslookup vDF)−1 or 2+333−333−1−1=0+0” are anomaly field values, the detector 140 may detect, as anomaly web logs, Log 5 that is a web log including “−1 OR 2+337−337−1=0+0+0+1” and Log 6 that is a web log including “$(nslookup vDF)−1 or 2+333−333−1−1=0+0”.

According to an embodiment, when at least one anomaly web log is detected, the detector 110 may generate a detection result report including information about the detected anomaly web log and may provide the detection result report to a user.

Here, the detection result report may include each field value detected as an anomaly field value, a score and appearance frequency of each anomaly field value, a client IP address included in a web log including each anomaly field value, etc. However, information included in the detection result report may further include a variety of information obtainable from detected anomaly web logs in addition to the above examples.

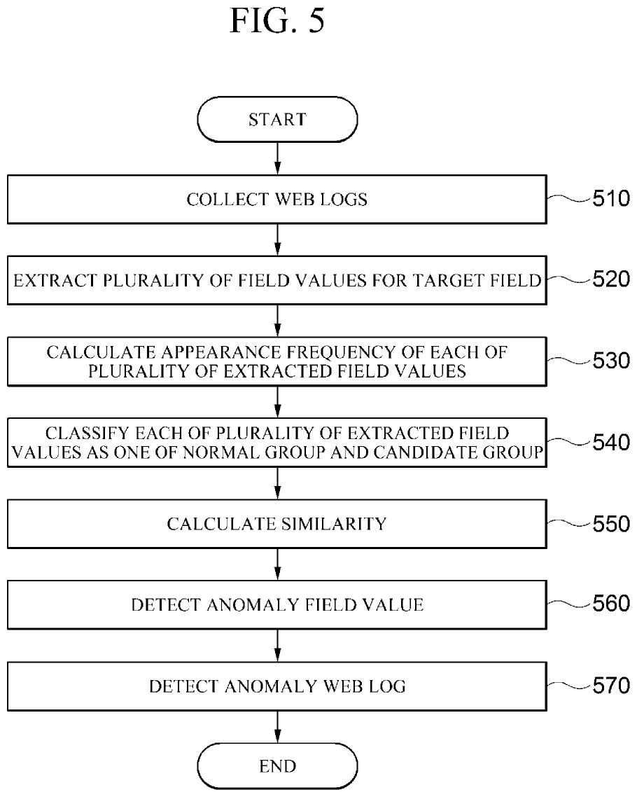

FIG. 5 is a flowchart illustrating a web scanning attack detection method according to an embodiment.

The method illustrated in FIG. 5, for example, may be performed by the web scanning attack detection device 100 illustrated in FIG. 1.

Referring to FIG. 5, the web scanning attack detection device 100 collects a plurality of web logs generated for a preset time with respect to each of at least one client connected to a web site (510).

Thereafter, the web scanning attack detection device 100 extracts a plurality of field values for a target field from the plurality of collected web logs (520).

Thereafter, the web scanning attack detection device 100 calculates an appearance frequency of each of the plurality of extracted field values in the plurality of web logs (530).

Thereafter, the web scanning attack detection device 100 classifies each of the plurality of field values as one of a normal group and a candidate group based on the calculated appearance frequency (540).

Here, according to an embodiment, the web scanning attack detection device 100 may classify, as the candidate group, field values having appearance frequencies that are less than the preset first threshold value among the plurality of field values.

Thereafter, the web scanning attack detection device 100 calculates a similarity between each field value classified as the normal group and each field value classified as the candidate group (550).

In detail, according to an embodiment, the web scanning attack detection device 100 may generate a token set for each of the plurality of field values by tokenizing each of the plurality of field values including each field value classified as the normal group and each field value classified as the candidate group, and may calculate the similarity using the token set for each field value classified as the normal group and the token set for each field value classified as the candidate group.

Here, according to an embodiment, the similarity between each field value classified as the normal group and each field value classified as the candidate group may be a Jaccard similarity.

Thereafter, the web scanning attack detection device 100 detects an anomaly field value among each field value classified as the candidate group based on the calculated similarity (560).

In detail, according to an embodiment, the web scanning attack detection device 100 may calculate a score for each field value classified as the candidate group based on the similarity calculated in operation 550, and may detect an anomaly field value among each field value classified as the candidate group based on the calculated score.

Here, according to an embodiment, the web scanning attack detection device 100 may calculate the score for each field value classified as the candidate group by adding up the similarity between each field value classified as the candidate group and each field value classified as the normal group.

Furthermore, according to an embodiment, the web scanning attack detection device 100 may detect, as an anomaly field value, a field value having a calculated score that is less than the preset second threshold value among each field value classified as the candidate group.

Thereafter, the web scanning attack detection device 100 detects an anomaly web log including the anomaly field value among the plurality of web logs (570).

In the flowchart illustrated in FIG. 5, at least some of the operations may be performed in combination with other operations, may be skipped, may be divided into detailed operations, or may be performed by adding at least one operation which is not shown.

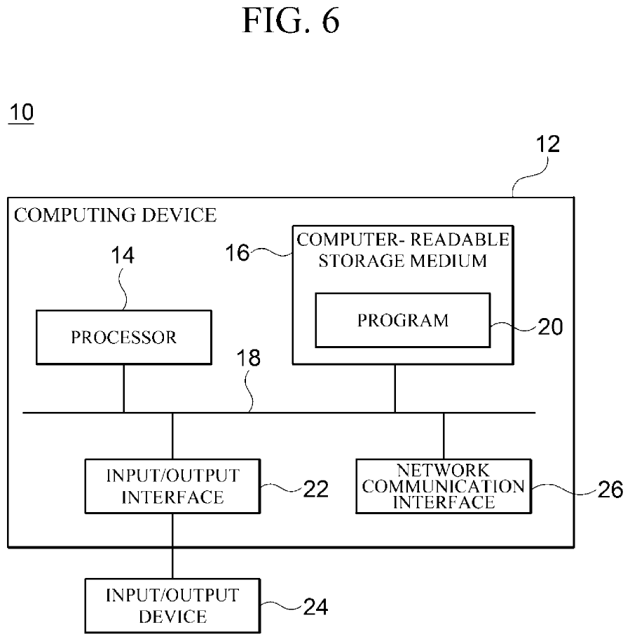

FIG. 6 is a block diagram exemplarily illustrating a computing environment that includes a computing device according to an embodiment. In the illustrated embodiment, each component may have different functions and capabilities in addition to those described below, and additional components may be included in addition to those described below.

The illustrated computing environment 10 includes a computing device 12. The computing device 12 may be one or more components included in the web scanning attack detection device 100 according to an embodiment.

The computing device 12 includes at least one processor 14, a computer-readable storage medium 16, and a communication bus 18. The processor 14 may cause the computing device 12 to operate according to the above-described example embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the example embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The example input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, a speaker, and/or a network card. The example input/output device 24 may be included inside the computing device 12 as a component constituting the computing device 12, or may be connected to the computing device 12 as a separate device distinct from the computing device 12.

According to the disclosed embodiments, the speed and accuracy of detection of a web scanning attack may be improved and unknown new attacks or variant attacks may also be detected efficiently by making it possible to detect a web scanning attack based on field values included in web logs generated for each client connected to a web site.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A web scanning attack detection device comprising:
a web log collector configured to collect a plurality of web logs generated for a preset time with respect to each of at least one client connected to a web site;
a field value extractor configured to extract a plurality of field values for a target field from the plurality of web logs;
a classifier configured to calculate an appearance frequency of each of the plurality of field values in the plurality of web logs and classify each of the plurality of field values as one of a normal group and a candidate group based on the appearance frequency; and
a detector configured to calculate a similarity between each field value classified as the normal group and each field value classified as the candidate group, detect an anomaly field value among each field value classified as the candidate group based on the similarity, and detect an anomaly web log including the anomaly field value among the plurality of web logs.

2. The web scanning attack detection device of claim 1, wherein the classifier classifies, as the candidate group, a field value having the appearance frequency that is less than a preset first threshold value among the plurality of field values.

3. The web scanning attack detection device of claim 1, wherein the detector generates a token set for each of the plurality of field values by tokenizing each of the plurality of field values; and
calculates the similarity using the token set for each field value classified as the normal group and the token set for each field value classified as the candidate group.

4. The web scanning attack detection device of claim 3, wherein the similarity is a Jaccard similarity.

5. The web scanning attack detection device of claim 1, wherein the detector calculates a score for each field value classified as the candidate group based on the similarity, and detects the anomaly field value among each field value classified as the candidate group based on the score.

6. The web scanning attack detection device of claim 5, wherein the detector calculates the score for each field value classified as the candidate group by adding up the similarity between each field value classified as the candidate group and each field value classified as the normal group.

7. The web scanning attack detection device of claim 5, wherein the detector detects, as the anomaly field value, a field value having the score that is less than a preset second threshold value among each field value classified as the candidate group.

8. A web scanning attack detection method comprising:
collecting a plurality of web logs generated for a preset time with respect to each of at least one client connected to a web site;
extracting a plurality of field values for a target field from the plurality of web logs;
calculating an appearance frequency of each of the plurality of field values in the plurality of web logs;
classifying each of the plurality of field values as one of a normal group and a candidate group based on the appearance frequency;
calculating a similarity between each field value classified as the normal group and each field value classified as the candidate group;
detecting an anomaly field value among each field value classified as the candidate group based on the similarity; and
detecting an anomaly web log including the anomaly field value among the plurality of web logs.

9. The web scanning attack detection method of claim 8, wherein in the classifying, a field value having the appearance frequency that is less than a preset first threshold value among the plurality of field values is classified as the candidate group.

10. The web scanning attack detection method of claim 8, wherein the calculating of the similarity comprises:
generating a token set for each of the plurality of field values by tokenizing each of the plurality of field values; and
calculating the similarity using the token set for each field value classified as the normal group and the token set for each field value classified as the candidate group.

11. The web scanning attack detection method of claim 10, wherein the similarity is a Jaccard similarity.

12. The web scanning attack detection method of claim 8, wherein the detecting of the anomaly field value comprises:
calculating a score for each field value classified as the candidate group based on the similarity; and
detecting the anomaly field value among each field value classified as the candidate group based on the score.

13. The web scanning attack detection method of claim 12, wherein in the calculating of the score, the score for each field value classified as the candidate group is calculated by adding up the similarity between each field value classified as the candidate group and each field value classified as the normal group.

14. The web scanning attack detection method of claim 12, wherein in the detecting of the anomaly field value, a field value having the score that is less than a preset second threshold value among each field value classified as the candidate group is detected as the anomaly field value.
